(19) United States
(12) Patent Application Publication
(10) Pub. No.: US 2015/0001344 A1
(43) Pub. Date: Jan. 1, 2015

(54) SATELLITE POSITIONING SYSTEM

(71) Applicant: Raytheon Company, Waltham, MA (US)

(72) Inventor: Gary Deel, Tucson, AZ (US)

(73) Assignee: Raytheon Company, Waltham, MA (US)

(21) Appl. No.: 13/927,664

(22) Filed: Jun. 26, 2013

(51) Int. Cl. B64G 1/00

(52) U.S. Cl. CPC B64G 1/002
USPC 244/158.5

(57) ABSTRACT

A satellite positioning system including a booster configured to launch and subsequently release a plurality of satellites is provided. Each satellite includes first and second stages and an interface to couple the first and second stages. The first stage includes a housing, satellite components disposed within the housing, a first fuel supply and maneuvering components configured to expend the first fuel supply to execute orbital maneuvers. The second stage includes an enclosure, a second fuel supply disposed within the enclosure and thrust elements supportively disposed on the enclosure and configured to expend the second fuel supply to drive a satellite towards orbit after release from the booster.

### BACKGROUND

The present invention relates to a satellite positioning system, and more specifically, to a satellite including a stage, which is to be jettisoned and which allows for orbit adjustments and trim upon release from a boost vehicle such that the satellite can be placed in orbit with a full onboard fuel complement.

In many satellite positioning systems, multiple satellites are placed in orbit in formation. As an example, a group of three satellites may be placed in a single orbit in a line where each satellite is separated from an adjacent satellite by a uniform distance. Such formations are achieved by launching the satellites into orbit using a rocket propelled booster that has a payload including each of the satellites. After launch, the satellites are released from the booster in series or as a group, at which point they are guided to their respective positions.

Typically, the group of satellites is released in a position where one of the satellites is in or close to its final orbital position. The other satellites in the group need to be driven from the release point to their respective orbital positions. This driving requires that onboard fuel be spent whereupon the formation of the satellites includes one satellite that may have a full or nearly full complement of onboard fuel and the others have almost no fuel. The lack of fuel in the other satellites limits the mission complexity of the group.

### SUMMARY

According to one embodiment of the present invention, a satellite positioning system including a booster configured to launch and subsequently release a plurality of satellites is provided. Each satellite includes first and second stages and an interface to couple the first and second stages. The first stage includes a housing, satellite components disposed within the housing, a first fuel supply and maneuvering components configured to expend the first fuel supply to execute orbital maneuvers. The second stage includes an enclosure, a second fuel supply disposed within the enclosure and thrust elements supportively disposed on the enclosure and configured to expend the second fuel supply to drive a satellite towards orbit after release from the booster.

According to another embodiment, a satellite is provided and includes a first stage including maneuvering components configured to expend a first fuel supply to execute orbital maneuvers in an orbit and to issue navigational commands for positioning the first stage in orbit and a second stage disposed to be jettisoned from the first stage and including an enclosure, a second fuel supply disposed within the enclosure and thrust elements supportively disposed on the enclosure. The thrust elements are responsive to the issued navigational commands and configured to expend the second fuel supply to help drive the satellite to orbit.

According to yet another embodiment, a satellite is provided and includes a first stage including a housing, satellite components disposed within the housing and maneuvering components configured to expend a first fuel supply to execute orbital maneuvers in an orbit and to issue navigational commands for positioning the first stage in orbit, a second stage including an enclosure, a second fuel supply disposed within the enclosure and thrust elements supportively disposed on the enclosure, the thrust elements being receptive of the issued navigational commands and configured to expend the second fuel supply to assist in driving the first stage to orbit in response to the reception of the issued navigational commands and an interface by which the first and second stages are coupled to one another. The interface is configured to jettison the second stage from the first stage by command of the maneuvering components.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of a satellite positioning system in accordance with embodiments;

FIG. 2 is a schematic illustration of a satellite in accordance with embodiments;

FIG. 3 is a side view of a second (upper) stage of the satellite of FIG. 2;

FIG. 4 is a top-down view of the second (upper) stage of the satellite of FIG. 2;

FIG. 5 is a bottom-up view of the second (upper) stage of the satellite of FIG. 2; and

FIG. 6 is a schematic diagram of a thrust element of the second (upper) stage of the satellite of FIG. 2.

### DETAILED DESCRIPTION

In accordance with aspects, a satellite (e.g., a cube-shaped satellite hereinafter referred to as a “CubeSat”) includes a first stage and a second stage. The second stage allows for an inexpensive method of performing orbit adjustments and/or trim upon release of the satellite from a rocket propelled booster. The second stage (i.e., an upper stage) includes a fuel storage tank and an array of valve actuated nozzles that are oriented in such a way as to provide thrust in predefined directions. Commands and power are provided by the first stage (i.e., a lower stage) via an interface connector. The second stage is expendable and upon completion of its mission, which may include the placing of the first stage in orbit, may be jettisoned via a release mechanism. The first stage is thus left in orbit with a full complement of fuel for further orbital maneuvers.

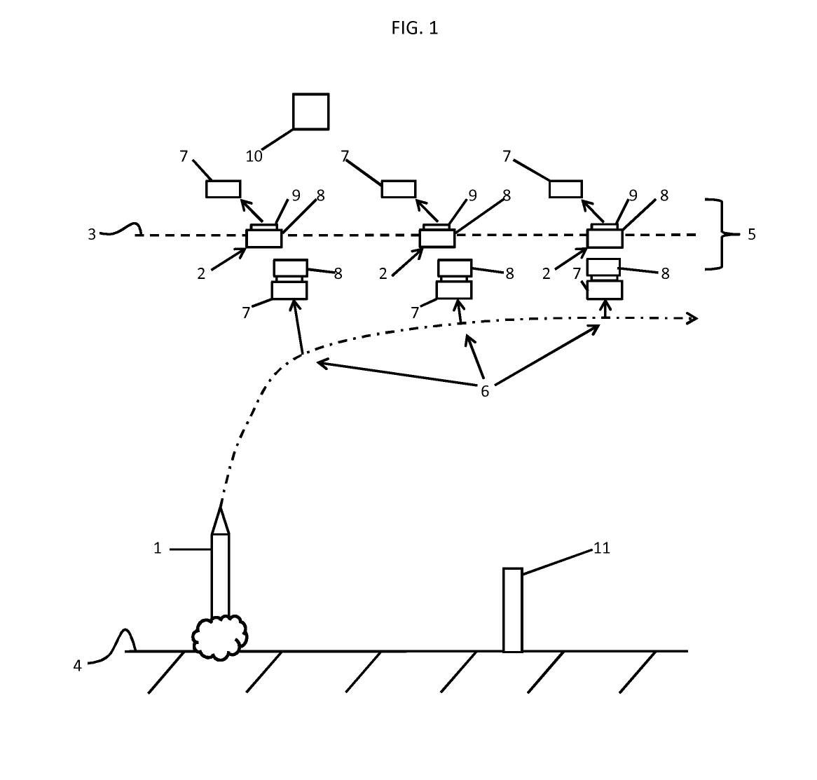

With reference to FIG. 1, a rocket propelled booster 1 is provided for launching three satellites 2 into orbit, such as low earth orbit 3. It is to be understood that the use of three satellites 2 is merely exemplary and that one or more satellites could be placed into orbit. In accordance with multiple aspects, the rocket propelled booster 1 may serve as a vehicle for launching the satellites 2 off the ground 4 and assisting the satellites 2 in forming a given formation 5 (e.g., a linear formation in which the satellites are separated by substantially uniform distances) once they are released at their respective release points 6.

As noted above, the rocket propelled booster 1 can relatively easily place one or more but not all of the satellites 2 in their proper respective positions. As such, one or more of the satellites 2 will have to be positioned following their respective release from the rocket propelled booster 1. In previous applications, this positioning was achieved by using fuel contained in the originally out-of-position satellite(s) and resulted in a formation in which the previously out-of-position satellite(s) was/were relatively low on fuel as compared to the others. Thus, the previously out-of-position satellite(s) could not participate in orbital maneuvers as easily and comprehensively as the others and mission complexity was necessarily limited.

As will be described below, however, this positioning can now be achieved without using up the fuel that would otherwise be useful in executing orbital maneuvers for the satellites 2. In accordance with aspects, the positioning is achieved by expending a separate fuel supply contained in a second stage 7 of the satellites 2. The second stages 7 can be jettisoned from respective first stages 8 of the satellites 2 by respective interface connectors 9 once the first stages 8 are placed in the low earth orbit 3.

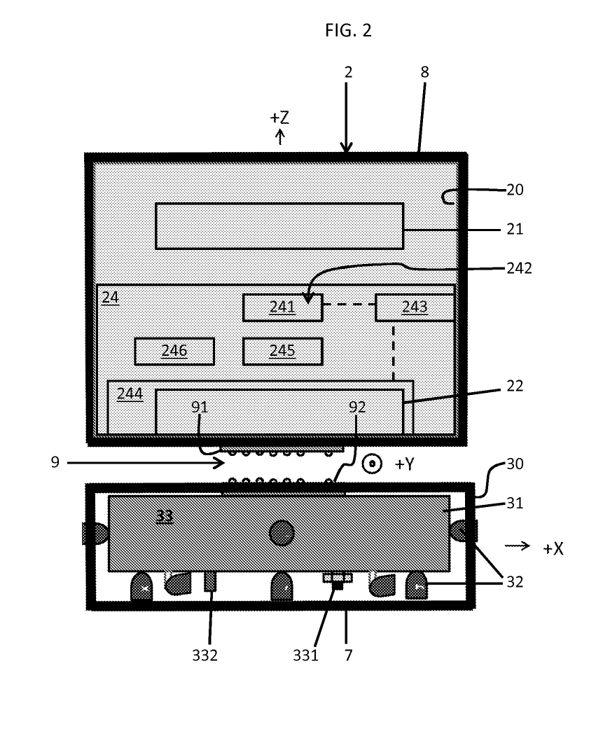

With reference to FIGS. 2-5, each satellite 2 of FIG. 1 includes a respective lower or first stage 8, a respective upper or second stage 7 and a respective interface connector 9. The first stage 8 is a substantially volumetric body and may be but is not required to be substantially cube-shaped (i.e., as in a CubeSat). The first stage 8 includes a housing 20 in which electronic satellite components 21 are housed for any application that might be desired, a jettison controller 22 and a navigational unit 24. As will be discussed below, the navigational unit 24 is configured to issue navigational commands for positioning the first stage 8 in the low earth orbit 3 and for executing orbital maneuvers once the first stage 8 is in the low earth orbit 3.

As shown in FIG. 2, the navigational unit 24 includes a tank 241, which contains a first fuel supply 242, a thrust element 243 that is coupled to the tank 241 and configured to expend the first fuel supply 242 to thereby execute orbital maneuvers once the first stage 8 is in the low earth orbit 3, a processor 244 configured to control operations of the thrust element 243, a receiver/transmitter 245 and a power source 246 configured to provide power to the other components. The processor 244 includes a processing unit and a storage unit that has executable instructions stored thereon. When executed, the executable instructions cause the processing unit to execute the operations described herein. In accordance with embodiments, the processor 244 may be operably coupled to one or both of the thrust element 243 and to the jettison controller 22 and, in some cases, the processor 244 may encompass the jettison controller 22.

The navigational unit 24 may be configured to locally generate the navigational commands in accordance with a predefined algorithm and/or current mission objectives with pre-installed guidance data and information. Alternatively, the navigational unit 24 may relay the navigational commands from an exterior transmitter such as a currently orbiting satellite 10 (see FIG. 1). As another alternative, the navigational unit 24 may relay the navigational commands from a ground-based transmitter 11 (see FIG. 1).

For each satellite 2, the second stage 7 is at least initially normally attached or coupled to the first stage 8 by the interface connector 9 but is disposed to be jettisoned from the first stage 8 at a predefined time (e.g., just before or once the first stage 8 is placed in the low earth orbit 3). As shown in FIG. 2, the second stage 7 includes an enclosure 30, which may have a similar shape as the housing 20 (though the enclosure 30 may be smaller than the housing 20), a storage tank 31 and an array of thrust elements 32. The storage tank 31 is configured to store a supply of a second fuel supply 33 and is housed in the enclosure 30. The second fuel supply 33 may be but is not required to be different from the first fuel supply 242 although the supplies are completely distinct from one another in terms of their use and placement in the satellite 2.

The storage tank 31 may be constructed of high tensile strength material that can withstand high pressures. The storage tank 31 may be filled with either cold gas or a liquid fuel (as the second fuel supply 33) that will expand when exposed to a vacuum without freezing. Any gas used must be extremely dry as any moisture will freeze and may clog the thrust elements 32. A maximum amount of the second fuel supply 33 that can be available for any given mission is defined by the size/volume of the storage tank 31 and the storage tank 31 can be increased or decreased in size to accommodate larger or smaller fuel requirements for various missions. For example, the enclosure 30 and the storage tank 31 can be as long as necessary in the −Z direction (see FIG. 2). Each thrust element 32 is supportively disposed on the enclosure 30 and is operably coupled to the storage tank 31. Thus, each thrust element 32 has access to the supply of the second fuel supply 33 in the storage tank 31 and can expend the second fuel supply 33 to generate thrust in response to the issued navigational commands of the navigational unit 24.

The interface connector 9 for each satellite 2 is a connective element by which the enclosure 30 of the second stage 7 is detachably coupled to the housing 20 of the first stage 8 such that the second stage 7 can be jettisoned. The interface connector 9 is further configured to relay the issued navigational commands from the navigational unit 24 to the thrust elements 32 and to execute a jettison of the second stage 7 in response to a jettison command issued by the jettison controller 22 or the processor 244 as the case may be.

In accordance with embodiments, the second stage 7 may be powered and controlled by the first stage 8 through the interface connector 9, which includes first connection component 91 that is supportively disposed on the housing 20 and second connection component 92 that is supportively disposed on the enclosure 30. When the second stage 7 is attached to the first stage 8, the first and second connection components 91 and 92 line up and permit communications between the first stage 8 (i.e., the navigational unit 24) and the various components of the second stage 7 to be described below.

In accordance with embodiments and, as shown in FIG. 4, the second connection component 92 includes a plurality of conductive leads 921, a pressure sensor lead 922, a separation indicator 923 and a power lead 924. Each of the plurality of conductive leads 921 respectively provides for communication between the navigational unit 24 and each of the thrust elements 32 of the second stage 7. The pressure sensor lead 922 provides for communication between the navigational unit 24 and the storage tank 31. A resistive circuit (not shown) may be provided between the power lead 924 and the separation indicator 923 whereby a loss of voltage will inform the navigational unit 24 that the second stage 7 has been jettisoned. The first connection component 91 is similarly configured.

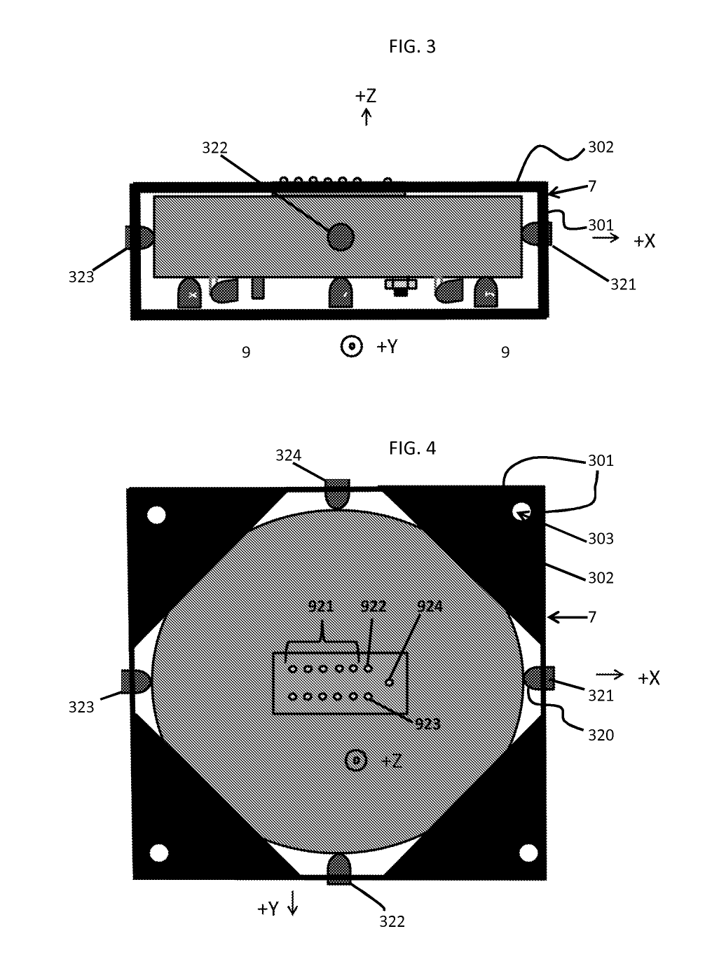

Further details of the second stage 7 will now be described with reference to FIGS. 3, 4 and 5. In accordance with embodiments and, as shown in FIGS. 3, 4 and 5, the enclosure 30 may have four sidewalls 301 and two end faces 302 that are provided at the respective corners of the sidewalls 301. Thus, the interior portions of the end faces 302 secure the storage tank 31 in an axial direction. At least the one of the end faces proximate to the first stage 8 may be formed to define mounting holes 303 by which the second stage 7 can be detachably coupled to the first stage 8. A releaseable fastener disposed in signal communication with the jettison controller 22 or the processor 244 and, in some cases, a spring element may be used as a mounting element that will permit the second stage 7 to be jettisoned from the first stage 8.

Each of the thrust elements 32 may include a nozzle portion 320 and, as shown in FIGS. 3 and 4, the nozzle portions 320 of first, second, third and fourth thrust elements 321, 322, 323, 324 are supportively disposed on each of the four sidewalls 301 such that a pair (i.e., the first and third thrust elements 321, 323) faces in opposite “X” directions and a pair (i.e., the second and fourth thrust elements 322, 324) faces in opposite “Y” directions. With this configuration, the first, second, third and fourth thrust elements 321, 322, 323, 324 may be controlled to execute lateral or “X” and “Y” directed guidance by the navigational unit 24.

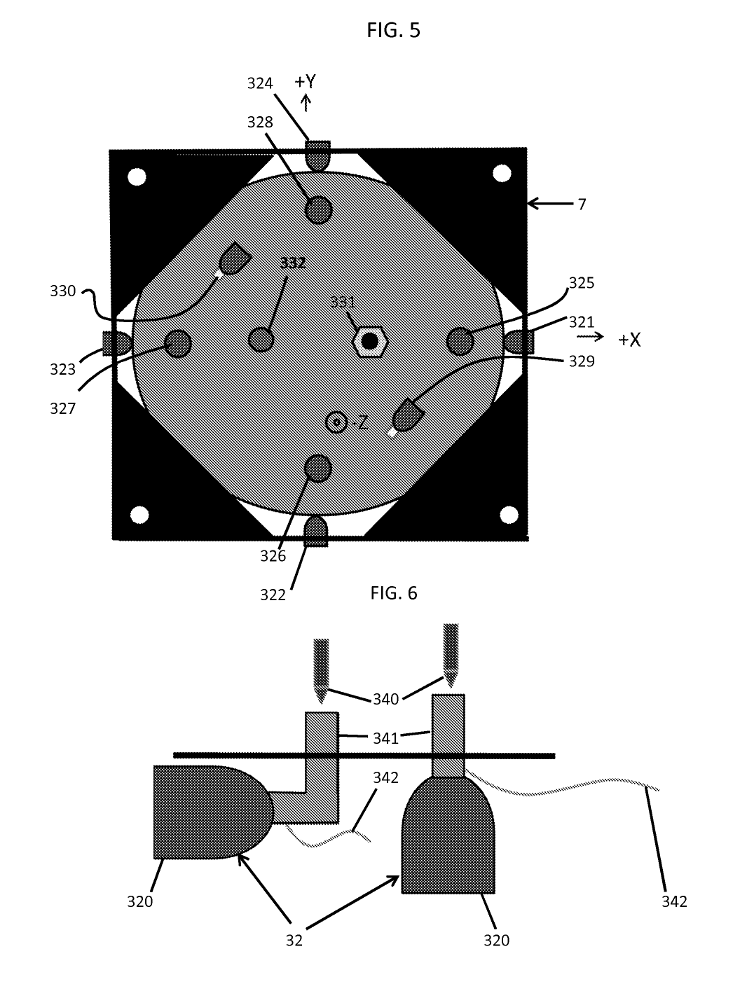

As shown in FIGS. 3 and 5, the second stage 7 further includes fifth, sixth, seventh and eighth thrust elements 325, 326, 327, 328 as well as ninth and tenth thrust elements 329, 330. The nozzle portions 320 of the fifth, sixth, seventh and eight thrust elements 325, 326, 327, 328 are supportively disposed on the exterior end face 302 and face in the same “Z” direction at an offset from a centerline of the second stage 7. The fifth, sixth, seventh and eight thrust elements 325, 326, 327, 328 therefore provide for advancing (or retreating) directed guidance of the second stage 7 when acting in concert or yaw rate control of the second stage 7 when acting separately in accordance with the navigational commands. The nozzle portions 320 of the ninth and tenth thrust elements 329, 330 are supportively disposed on the exterior end face 302 and are disposed to provide for roll control of the second stage 7 in accordance with the navigational commands.

The nozzle portions 320 of each of the thrust elements 32 may but are not required to abut an exterior surface of the storage tank 31. With such a configuration, the nozzle portions 320 can be receptive of the second fuel supply 33 with limited flowpath hardware. In addition, the abutment of the nozzle portions 320 can be employed to secure the storage tank 31 in position within the enclosure 30.

As shown in FIGS. 2 and 5, the second stage 7 may further include a fuel fill port 331 by which the storage tank 31 can be filled and a pressure sensor 332. In accordance with embodiments, the pressure sensor 332 is disposed to measure a pressure within the storage tank 31 to thereby determine and monitor a fuel status therein. The pressure sensors 332 may also be disposed to monitor the fuel status during launch operations.

With reference to FIG. 6, each thrust element 32 may include a needle valve 340, a solenoid assembly 341 and a conductive element 342 (e.g., a 5 volt control wire). The nozzle portions 320 are opened and closed in response to a voltage being applied to the conductive element 342. The solenoid assembly 341 responds to this voltage by pulling up the needle valve 340, which allows the second fuel supply 33 to flow from the storage tank 31 into the corresponding bell shaped nozzle portion 320 to generate thrust. The needle valve 340 may be spring-loaded such that the needle valve 340 closes and shuts off the flow of the second fuel supply 33 when the 5 volt signal is removed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A satellite positioning system including a booster configured to launch and subsequently release a plurality of satellites, each satellite comprising:
first and second stages and an interface to couple the first and second stages;
the first stage including a housing, satellite components disposed within the housing, a first fuel supply and maneuvering components configured to expend the first fuel supply to execute orbital maneuvers; and
the second stage including an enclosure, a second fuel supply disposed within the enclosure and thrust elements supportively disposed on the enclosure and configured to expend the second fuel supply to drive a satellite towards orbit after release from the booster.

2. The satellite positioning system according to claim 1, wherein the first stage of each satellite includes a tank for containing the first fuel supply.

3. The satellite positioning system according to claim 1, wherein the interface is configured to both secure and jettison the second stage to and from the first stage.

4. The satellite positioning system according to claim 1, wherein the maneuvering components control the interface and determine when to jettison the second stage.

5. The satellite positioning system according to claim 1, wherein the maneuvering components are connected to the thrust elements of the second stage via the interface.

6. The satellite positioning system according to claim 1, wherein the maneuvering components generate navigational commands locally, relay externally generated navigational commands and/or relay ground-based navigational commands.

7. The satellite positioning system according to claim 1, wherein the second fuel supply comprises a cold fuel.

8. The satellite positioning system according to claim 1, wherein the thrust elements comprise one or more of advancing, lateral, yaw and rotational thrust elements.

9. The satellite positioning system according to claim 1, wherein the thrust elements comprise a needle valve and a solenoid assembly.

10. A satellite, comprising:
a first stage including maneuvering components configured to expend a first fuel supply to execute orbital maneuvers in an orbit and to issue navigational commands for positioning the first stage in orbit; and
a second stage disposed to be jettisoned from the first stage and including an enclosure, a second fuel supply disposed within the enclosure and thrust elements supportively disposed on the enclosure;
the thrust elements being responsive to the issued navigational commands and configured to expend the second fuel supply to help drive the satellite to orbit.

11. The satellite according to claim 10, wherein the second stage has sufficient fuel that the first stage reaches orbit without having to expend the first supply fuel.

12. The satellite according to claim 10, further comprising an interface by which the first and second stages are coupled to one another.

13. The satellite according to claim 12, wherein the interface is configured to jettison the second stage from the first stage by command of the maneuvering components.

14. The satellite according to claim 12, wherein the maneuvering components guide the thrust elements of the second stage via the interface.

15. The satellite according to claim 10, wherein the maneuvering components generate navigational commands locally, relay externally generated navigational commands and/or relay ground-based navigational commands.

16. The satellite positioning system according to claim 10, wherein the second fuel supply comprises a cold fuel.

17. The satellite positioning system according to claim 10, wherein the thrust elements comprise one or more of advancing, lateral, yaw and rotational thrust elements.

18. The satellite positioning system according to claim 10, wherein the thrust elements comprise a needle valve and a solenoid assembly

19. A satellite, comprising:
a first stage including a housing, satellite components disposed within the housing and maneuvering components configured to expend a first fuel supply to execute orbital maneuvers in an orbit and to issue navigational commands for positioning the first stage in orbit;
a second stage including an enclosure, a second fuel supply disposed within the enclosure and thrust elements supportively disposed on the enclosure, the thrust elements being receptive of the issued navigational commands and configured to expend the second fuel supply to assist in driving the first stage to orbit in response to the reception of the issued navigational commands; and
an interface by which the first and second stages are coupled to one another, the interface being configured to jettison the second stage from the first stage by command of the maneuvering components.

20. The satellite according to claim 19, wherein the first stage includes a full complement of the first fuel supply when the first stage reaches orbit.
